(19) United States
(12) Patent Application Publication
(10) Pub. No.: US 2020/0266509 A1
(43) Pub. Date: Aug. 20, 2020

(54) AIR BATTERY, AIR BATTERY SYSTEM AND VEHICLE WITH MOUNTED AIR BATTERY SYSTEM

(71) Applicant: TOYOTA JIDOSHA KABUSHIKI KAISHA, Toyota-shi (JP)

(72) Inventors: Takeo YAMAGUCHI, Susono-shi (JP); Hiroshi Suyama, Mishima-shi (JP); Yutaka Hirose, Shizuoka-ken (JP)

(21) Appl. No.: 16/749,766

(22) Filed: Jan. 22, 2020

(30) Foreign Application Priority Data
Feb. 14, 2019 (JP) 2019024775

(51) Int. Cl. H01M 12/08; H01M 4/50; H01M 10/667; H01M 4/52; H01M 10/615; H01M 4/02

(52) U.S. Cl. CPC H01M 12/08; H01M 4/50; H01M 10/667; H01M 2220/20; H01M 10/615; H01M 2004/027; H01M 4/52

(57) ABSTRACT

It is an object of the disclosure to provide a novel air secondary battery, air secondary battery system, and vehicle with the mounted air secondary battery system. The air secondary battery of the disclosure comprises, as the negative electrode active material, an oxide that is capable of topotactic insertion and dissociation of oxygen atoms. The air secondary battery system of the disclosure has an air secondary battery and a heat source that supplies heat to the air secondary battery. The vehicle of the disclosure has the air secondary battery system described above mounted in it and uses the electric power provided by the air secondary battery as at least part of its drive power.

### FIELD

The present disclosure relates to an air battery, to an air battery system, and to a vehicle with a mounted air battery system.

### BACKGROUND

Air batteries are able to utilize oxygen in the air as a positive electrode active material and are therefore advantageous, having high volumetric energy density and being relatively easy to reduce in size and weight. Research on chargeable air batteries, i.e. air secondary batteries, is also being pursued with the aim of thither making use of the advantages of air batteries.

Known negative electrode active materials that are used in air secondary batteries include alkali metals, alkaline earth metals, aluminum and zinc.

Air secondary batteries that utilize such negative electrode active materials are associated with problems, however, such as formation of a passivity film on the surface of the negative electrode active material during discharge, and growth of dendrites from the surface of the negative electrode active material layer during charge.

In this regard, PTL 1 discloses a cobalt air secondary battery that utilizes cobalt as the negative electrode active material. The same publication indicates that the cobalt used as the negative electrode active material is resistant to dissolution and morphological change, even without additives.

PTL 2 discloses an air secondary battery using an alkali metal, an alkaline earth metal or aluminum as the negative electrode active material, and the use of an organic electrolyte solution as an electrolyte solution, having low reactivity with these negative electrode active, materials.

In an air secondary battery, hydroxide ions migrate between the positive and negative electrodes during charge-discharge. The battery disclosed in NPL 1, for example, is an example of a non-air battery in which hydroxide ions migrate between the positive and negative electrodes during charge-discharge.

NPL 1 discloses a secondary battery utilizing iron-based perovskite-type oxides for both the positive electrode active material and negative electrode active material.

### CITATION LIST

### Patent Literature

[PTL 1] Japanese Unexamined Patent Publication HEI No. 5-121105

[PTL 2] Japanese Unexamined Patent Publication HEI No. 5-258782

### Non-Patent Literature

[NPL 1] Hibino et al, SCIENTIFIC REPORTS, Aug. 24, 2012

### SUMMARY

### Technical Problem

Air secondary batteries utilizing metals such as alkali metals, alkaline earth metals, aluminum, zinc and cobalt as the negative electrode active material are therefore known, as disclosed in PTLs 1 and 2.

When an air secondary battery of this type has been charged, a passive state is formed on the surface of the negative electrode active material, in a manner depending on the type of negative electrode active material. This is thought to occur due to oxidation as the negative electrode active material undergoes a primary phase change.

Moreover, when an air secondary battery of this type has been charged, dendrites also grow from the surface of the negative electrode active material layer, in a manner likewise depending on the type of negative electrode active material. This is thought to occur due to dissolution and deposition of the negative electrode active material during charge-discharge reaction of the air secondary battery.

With this in mind, the present inventors have investigated air secondary batteries that are able to minimize such problems.

Batteries using metal oxides as the positive electrode active material and negative electrode active material may tend to have lower energy density. It is also possible that such batteries may tend to have lower battery voltage, because of a smaller difference in oxidation-reduction potential between the positive electrode active material and negative electrode active material.

It is an object of the present disclosure to provide a novel air secondary battery, air secondary battery system, and vehicle with the mounted air secondary battery system.

### Solution to Problem

The present inventors have found that the aforementioned object can be achieved by the following means:

### Aspect 1

An air secondary battery having a negative electrode active material layer, an electrolyte solution layer and an air electrode layer in that order, wherein:
the negative electrode active material layer comprises, as the negative electrode active material, an oxide that is capable of topotactic insertion and dissociation of oxygen atoms.

### Aspect 2

The air secondary battery according to aspect 1, wherein the oxide is a perovskite-type, brownmillerite-type, kagome lattice-type or delafossite-type metal oxide.

### Aspect 3

The air secondary battery according to aspect 1 or 2, wherein the oxide is CaFeO₃, YBaCo₄O_{8.5}, YCr₁₋ₓPₓO₄ (X: 0, 0,3, 0.5 or 0.7), BaYMn₂O_{5+δ}, Ca₂AlMnO_{5+δ}, or BaLnMn₂O_{5+δ} (Ln: Pr, Nd, Sm, Gd, Dy, Er and/or Y).

### Aspect 4

The air secondary battery according to any one of aspects 1 to 3, which further has a negative electrode collector layer, and has the negative electrode active material layer, the electrolyte solution layer and the air electrode layer in that order on each of both sides of the negative electrode collector layer.

### Aspect 5

An air secondary battery system having an air secondary battery according to any one of aspects 1 to 4, and a heat source that supplies heat to the air secondary battery.

### Aspect 6

The air secondary battery system according to aspect 5, wherein the heat source includes another battery other than the air secondary battery.

### Aspect 7

A vehicle having an air secondary battery system according to aspect 5 or 6 mounted in it and using the electric power provided by the air secondary battery as at least part of its drive power.

### Aspect 8

The vehicle according to aspect 7, wherein the vehicle uses either or both the air secondary battery and an internal combustion engine as drive power with alternated switching, and the heat source includes the internal combustion engine.

### Advantageous Effects of Invention

According to the present disclosure it is possible to provide a novel air secondary battery, air secondary battery system, and vehicle with the mounted air secondary battery system.

### BRIEF DESCRIPTION OF DRAWINGS

FIG. 1 is a schematic view showing an air secondary battery according to one embodiment of the disclosure.

FIG. 2 is a schematic view showing an air secondary battery according to another embodiment of the disclosure.

FIG. 3 is a schematic view showing an air secondary battery system according to one embodiment of the disclosure.

FIG. 4 is a schematic view showing a vehicle in which an air secondary battery system according to one embodiment of the disclosure is mounted.

FIG. 5 is a cyclic voltammogram showing the reduction and oxidation peaks for YBaCo₄O_{7+δ} as a negative electrode active material.

### DESCRIPTION OF EMBODIMENTS

Embodiments of the disclosure will now be explained in detail. The disclosure is not limited to the embodiments described below, however, and various modifications may be implemented within the scope of the gist thereof.

### Air Secondary Battery

The air secondary battery of the disclosure is an air secondary battery having a negative electrode active material layer, an electrolyte solution layer and an air electrode layer in that order. The negative electrode active material layer comprises, as the negative electrode active material, an oxide that is capable of topotactic insertion and dissociation of oxygen atoms.

Without being strictly limited to any specific principle, one principle of the air secondary battery of the disclosure will now be explained based on an example using a perovskite-type metal oxide as the negative electrode active material, as a concrete example of an oxide allowing topotactic insertion and dissociation of oxygen atoms.

When a perovskite-type metal oxide is used as the negative electrode active material, the electrochemical reaction within the battery is thought to be as represented by the following formula. The reaction on the right side of this formula is thought to occur during battery discharge.

Negative electrode reaction: ABO₂+2OH⁻←→ABO₃+H₂O+2e⁻

Air electrode reaction: ½O₂+H₂O+2e⁻←→2OH⁻

Overall reaction: ABO₂+½O₂←→ABO₃

In the negative electrode reaction, the perovskite-type metal oxide is a layered oxide having a structure in which oxygen is inserted between layers of metal A and B, the crystalline structure after insertion and the crystalline structure after dissociation of oxygen atoms both being maintained as the same crystalline structure.

Therefore, unlike metals that have been conventionally used as negative electrode active materials for air secondary batteries, such metal oxides used in the negative electrode active material layer minimize phase transition on the negative electrode active material surface during charge. This helps to prevent formation of a passivity film by oxide of the negative electrode active material during charge, which has been a problem associated with conventional air secondary batteries.

Furthermore, since there is also no dissolution of metal from the perovskite-type metal oxide in the reaction that takes place during, discharge, formation of dendrites on the negative electrode active material surface during charge is also unlikely to occur.

### Negative Electrode Active Material

The negative electrode active material of the air secondary battery of the disclosure is an oxide that is capable of topotactic insertion and dissociation of oxygen atoms.

Such an oxide may be an interlayer compound having oxygen atoms disposed between multiple metal atom layers, for example. An oxide of this type may be a perovskite-type, brownmillerite-type, kagome lattice-type or delafossite-type metal oxide. Metal oxides having such crystalline structures are stable in their crystalline structures, the crystalline structures being easily maintained even when oxygen dissociates from the crystalline structures by oxidation-reduction reaction.

More specifically, such oxides include, but are not, limited to, CaFeO₃, YBaCo₄O_{8.5}, YCr₁₋ₓPₓO₄ (X: 0, 0.3, 0.5 or 0.7), BaYMn₂O_{5+δ}, Ca₂AlMnO_{5+δ}, and BaLnMn₂O_{5+δ} (Ln: Pr, Nd, Sm, Gd, Dy, Er and/or Y).

### Other Structures

The air secondary battery of the disclosure also has a negative electrode active material layer, an electrolyte solution layer and an air electrode layer, in that order. The negative electrode active material layer comprises the aforementioned oxide as the negative electrode active material.

The air secondary battery of the disclosure may also have a negative electrode collector layer, and a negative electrode active material layer, an electrolyte solution layer and an air electrode layer in that order on each of both sides of the negative electrode collector layer. If the air secondary battery has this type of construction, then two air secondary batteries will be sharing a single negative electrode collector layer, and therefore the volume of the battery can be reduced while increasing the volumetric energy density.

The air secondary battery of the disclosure may also have an air electrode collector and a hydrophobic membrane. The air secondary battery of the disclosure may also be encapsulated in an exterior body.

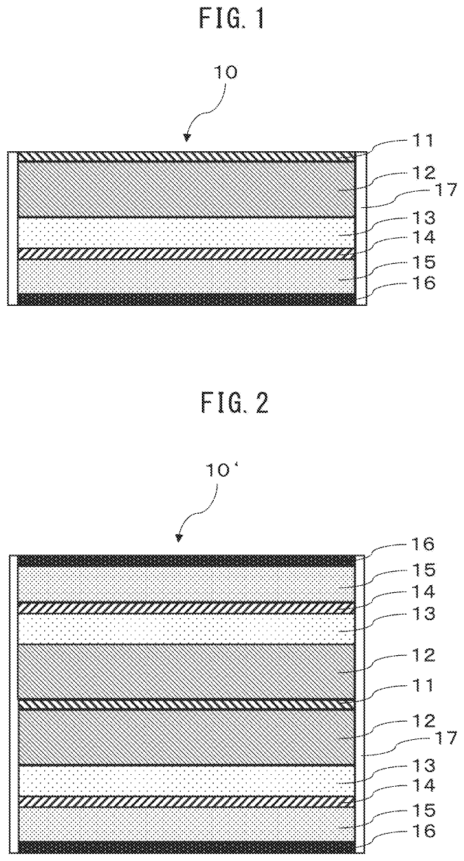

FIG. 1 is a schematic view showing an air secondary battery according to one embodiment of the disclosure. The air secondary battery 10 shown in FIG. 1 has a negative electrode collector layer 11, a negative electrode active material layer 12, an electrolyte solution layer 13, an air electrode collector layer 14, an air electrode layer 15 and a hydrophobic membrane 16, in that order.

During discharge with the air secondary battery 10 shown in FIG. 1, oxygen is supplied through the hydrophobic membrane 16 to the air electrode layer 15. In the air electrode layer 15, oxygen accepts electrons supplied from the air electrode collector layer 14, and reacts with water in the electrolyte solution to produce hydroxide ions. The hydroxide ions are transmitted through the electrolyte solution layer 13 and reach the negative electrode active material layer 12. In the negative electrode active material layer 12, the hydroxide ions release their electrons to form oxygen atoms and water, the oxygen atoms being taken up into oxides in the negative electrode active material layer 12 that are capable of topotactic insertion and dissociation of oxygen atoms. The electrons released from the hydroxide ions are supplied to the negative electrode collector layer 11.

The air electrode collector layer 14 and air electrode layer 15 may also be disposed in the reverse order from the mode shown in FIG. 1. That is, the air electrode collector layer 14 may be disposed between the air electrode layer 15 and the electrolyte solution layer 13, or on the opposite side from the side of the air electrode layer 15 on which the electrolyte solution layer 13 is disposed, such as between the air electrode layer 15 and the hydrophobic membrane 16. In other words, the electrolyte solution layer 13, air electrode collector layer 14 and air electrode layer 15 may be disposed in that order, or in the order: electrolyte solution layer 13, air electrode layer 15, air electrode collector layer 14.

FIG. 2 is a schematic view showing an air secondary battery according to another embodiment of the disclosure. The air secondary battery 10 shown in FIG. 2 has a structure in which two air secondary batteries having the structure shown in FIG. 1 are disposed sharing the same negative electrode collector layer 11, and facing each other across and sandwiching the negative electrode collector layer 11. In other words, the air secondary battery 10 shown in FIG. 2 has the negative electrode active material layer 12, electrolyte solution layer 13, air electrode collector layer 14, air electrode layer 15 and hydrophobic membrane 16 in that order, from both sides of the negative electrode collector layer 11.

### (Negative Electrode Collector Layer)

The air secondary battery of the disclosure may have a negative electrode collector layer. Thee material of the negative electrode collector layer is not particularly restricted so long as it is electrically conductive, and examples include stainless steel, nickel, copper and carbon. The material used as the negative electrode collector layer is preferably one that is stable in the electrolyte solution under the conditions in which the air secondary battery is to be used.

The form of the negative electrode collector layer may be, for example, a foil, sheet, mesh or the like.

### (Negative Electrode Active Material Layer)

The negative electrode active material aver comprises, as the negative electrode active material, at least an oxide that is capable of topotactic insertion and dissociation of oxygen atoms. The negative electrode active material layer may also optionally comprise an electrolyte solution, a conductive aid and a binder.

The description below regarding the electrolyte solution layer may be referred to for the electrolyte solution.

For example, the conductive aid may be, but is not limited to, a carbon material such as VGCF (Vapor Grown Carbon Fibers) or carbon nanofibers, or a metal material.

The binder may be polyvinylidene fluoride (PVdF), polytetrafluoroethylene (PTFE), styrene-butadiene rubber (SBR) or the like, with no limitation to these.

### (Electrolyte Solution Layer)

The electrolyte solution layer includes at least an electrolyte solution. The electrolyte solution included in the electrolyte solution layer may be any type of electrolyte solution that is conductive for hydroxide ions.

Examples of such electrolyte solutions include, but are not limited to, aqueous alkali solutions, and specifically sodium hydroxide aqueous solutions and potassium hydroxide aqueous solutions.

The electrolyte solution layer may optionally include a separator to ensure insulation between the air electrode layer and negative electrode active material layer. The separator used may be any material that can hold the electrolyte solution and can ensure insulation between the air electrode layer and the negative electrode active material layer.

The material of the separator may be any separator material that is usable in an air secondary battery, examples of which include porous films of polyethylene, polypropylene, polyethylene terephthalate or cellulose, and nonwoven fabrics such as resin nonwoven fabrics and glass fiber nonwoven fabrics.

The separator preferably has a porous structure from the viewpoint of holding the electrolyte solution. The porous structure of the separator is not particularly restricted so long as it can hold the electrolyte solution, and for example, it may be a mesh structure with regularly arranged constituent fibers, a nonwoven fabric structure with randomly arranged constituent fibers, or a three-dimensional network structure with independent pores or communicating pores.

### (Air Electrode Layer)

The air electrode layer has at least a conducting material. The air electrode layer may include a catalyst, an electrolyte solution and a binder.

The conducting material is not particularly restricted so long as it is conductive, and it may be a carbon material such as mesoporous carbon, graphite, acetylene black, carbon black, carbon nanotubes or carbon fibers, or a metal material, for example.

The catalyst may be any catalyst that is commonly used in air battery air electrodes and promotes oxygen reduction reaction. The catalyst may also be supported on the conducting material.

Examples of catalysts include, but are not limited to, precious metals such as ruthenium, rhodium, palladium and platinum.

### (Air Electrode Collector Layer)

The air secondary battery of the disclosure may have an air electrode collector layer.

The material of the air electrode collector layer is not particularly restricted so long as it is electrically conductive, and examples include stainless steel, nickel, copper and carbon. From the viewpoint of air (oxygen) diffusibility, it preferably has a porous structure, such as a mesh. The form of the air electrode collector may be, for example, a foil, sheet, mesh (grid) or the like.

### (Hydrophobic Membrane)

The hydrophobic membrane is not particularly restricted so long as it is a material through which the electrolyte solution does not leak to the exterior of the air secondary battery and allows oxygen supplied from outside the air secondary battery to reach the air electrode. Examples for the hydrophobic membrane include a porous fluorine resin sheet (PTFE or the like), or water-repellent treated porous cellulose.

### Air Secondary Battery System

The air secondary battery system of the disclosure has an air secondary battery and a heat source that supplies heat to the air secondary battery.

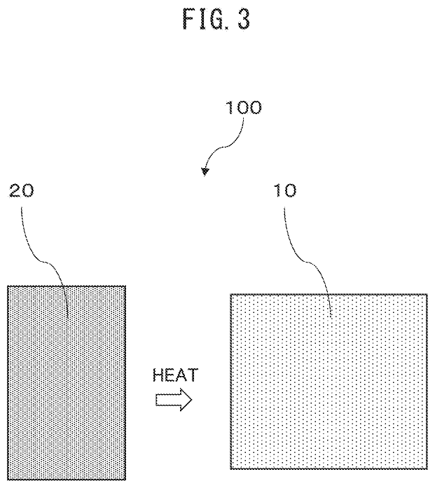

FIG. 3 is a schematic view showing an air secondary battery system according to one embodiment of the disclosure. The air secondary battery system 100 shown in FIG. 3 has an air secondary battery 10 and a heat source 20. The air secondary battery 10 in FIG. 3 has the same construction as the air secondary battery shown in FIG. 1. The air secondary battery system 100 shown in FIG. 3 supplies heat from the heat source 20 to the air secondary battery 10 during battery discharge.

The oxide capable of topotactic insertion and dissociation of oxygen atoms will usually be a highly stable substance. Therefore, the cell reaction in the air secondary battery of the disclosure utilizing such an oxide as the negative electrode active material would be expected to take place relatively slowly.

The present inventors have found that by supplying heat to an oxide that is capable of topotactic insertion and dissociation of oxygen atoms in the air secondary battery of the disclosure, and particularly the negative electrode active material layer, such oxides are activated and the cell reaction is accelerated.

### Heat Source

In the air secondary battery system of the disclosure, the heat source supplies heat to the air secondary battery. The heat source may be any heat source able to supply heat to the air secondary battery. The heat source may be a heater, a heat pipe or another battery, for example. When another battery is used as the heat source, the heat generated inside the battery during charge-discharge of the other battery may be supplied to the air secondary battery.

By supplying heat from a heat source, the negative electrode active material layer of the air secondary battery may be heated up to a maximum temperature of, for example, 30° C. to 500° C. in the negative electrode active material layer. The maximum temperature in the negative electrode active material layer that has been heated by supply of heat from the heat source may be 0° C. or higher, 50° C. or higher, 70° C. or higher or 90° C. or higher, and 500° C. or less, 400° C. or less, 300° C. or less, 200° C. or less or 100° C. or less. The maximum temperature in the negative electrode active material layer is preferably a lower temperature than the boiling point of the electrolyte solution, such as below 100° C., for example.

### Vehicle

The vehicle of the disclosure has the air secondary battery system described above mounted in it and uses the electric power provided by the air secondary battery as at least part of its drive power.

This type of vehicle may be an automobile, train, airplane or ship with the air secondary battery system of the disclosure mounted in it, although there is no limitation to these.

The vehicle of the disclosure may also be a vehicle driven by electrical energy, such as an electric vehicle. An electric vehicle can use oxygen in the air that has been taken into the vehicle as running wind during traveling, as oxygen to be used in the air secondary battery of the disclosure.

In addition, preferably the vehicle of the disclosure is a vehicle using either or both the air secondary battery of the disclosure and an internal combustion engine as drive power with alternated switching, and the heat source includes the internal combustion engine. A vehicle having such a construction allows heat generated when the internal combustion engine has been actuated, to accelerate the cell reaction of the air secondary battery of the disclosure, thus increasing its energy efficiency.

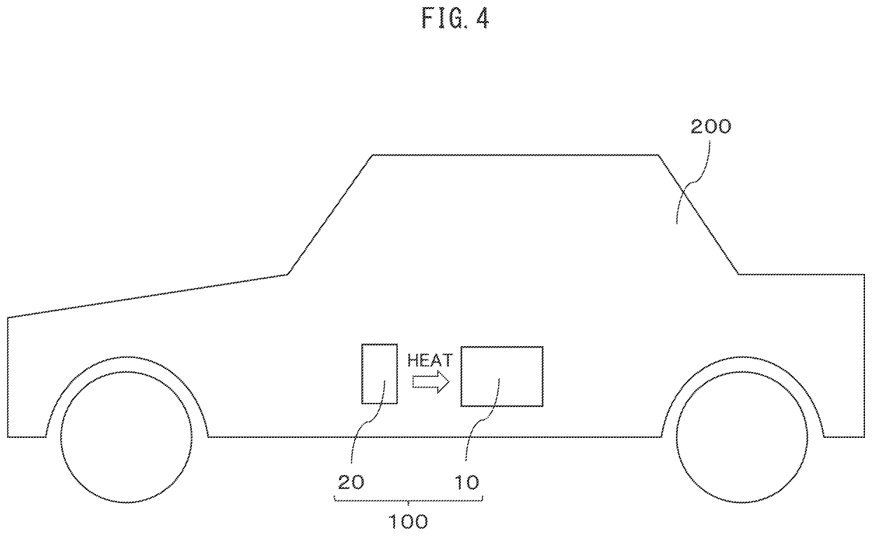

FIG. 4 is a schematic view showing a vehicle in which an air secondary battery system according to one embodiment of the disclosure is mounted. The vehicle 200 shown in FIG. 4 has an air secondary battery system 100 mounted in it, the system comprising an air secondary battery of the disclosure 10 and a heat source 20.

### EXAMPLES

### Example 1

Cyclic voltammetry was carried out under the conditions shown in Table 1, and the reduction peak for YBaCo₄O_{7+δ} as a negative electrode active material was observed.

TABLE 1

| Working electrode | YBaCo₄O_{7+δ} + Ti-based carbon electrode | |
|---|---|---|
| Counter electrode | Ti-base carbon electrode | |
| Reference electrode | Mercury/mercury oxide electrode | |
| Electrolyte solution | Aqueous KOH solution (1 mol/l) | |
| Sweep rate | 1 | mV/s |
| Temperature | 25° | C. |

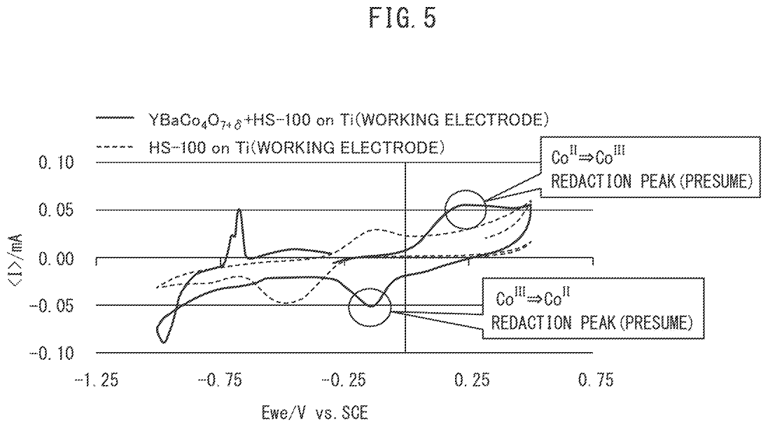

FIG. 5 is a cyclic voltammogram showing the reduction peak for YBaCo₄O_{7+δ} as a negative electrode active material. As shown in FIG. 5 under the conditions of Table 1, YBaCo₄O_{7+δ} was observed to have a peak indicating reduction at about −0.15 V.

Reduction was thus possible by supplying electrons and water to YBaCo₄O_{7+δ} as the negative electrode active material.

### Example 2

Oxidation of YBaCo₄O₇ as the negative electrode active material was evaluated by conducting thermogravimetry (TG) and differential scanning calorimetry (DSC) simultaneously.

Thermogravimetry (TG) and differential scanning calorimetry (DSC) were carried out simultaneously for YBaCo₄O_{7+δ} as the negative electrode active material, under constant conditions in air at 300° C.

A heat value of 2387 kJ/L was measured as a result of the differential scanning calorimetry (DSC). This heat value was calculated based on a sample density of 5.41 g/cm³.

As a result of thermogravimetry (TG), YBaCo₄O₇ was found to have a weight change of 2.67%. The weight change was assumed to be the change in weight due to oxidation of YBaCo₄O₇ to YBaCo₄O_{7+δ}. If the sample used in the experiment is assumed to be a single phase, this corresponds to δ=0.96.

The YBaCo₄O₇ was thus confirmed to be oxidized.

### REFERENCE SIGNS LIST

10 Air secondary battery

11 Negative electrode collector layer

12 Negative electrode active material layer

13 Electrolyte solution layer

14 Air electrode collector layer

15 Air electrode layer

16 Hydrophobic membrane

20 Heat source

100 Air secondary battery system

200 Vehicle

1. An air secondary battery having a negative electrode active material layer, an electrolyte solution layer and an air electrode layer in that order, wherein:
the negative electrode active material layer comprises, as the negative electrode active material, an oxide that is capable of topotactic insertion and dissociation of oxygen atoms.

2. The air secondary battery according to claim 1, wherein the oxide is a perovskite-type, brownmillerite-type, kagome lattice-type or delafossite-type metal oxide.

3. The air secondary battery according to claim 1, wherein the oxide is CaFeO₃, YBaCo₄O_{8.5}, YCr₁₋ₓPₓO₄ (X: 0, 0.3, 0.5 or 0.7), BaYMn₂O_{5+δ}, Ca₂AlMnO_{5+δ}, or BaLnMn₂O_{5+δ} (Ln: Pr, Nd, Sm, Gd, Dy, Er and/or Y).

4. The air secondary battery according to claim 1, which further has a negative electrode collector layer, and has the negative electrode active material layer, the electrolyte solution layer and the air electrode layer in that order on each of both sides of the negative electrode collector layer.

5. An air secondary battery system having an air secondary battery according to claim 1, and a heat source that supplies heat to the air secondary battery.

6. The air secondary battery system according to claim 5, wherein the heat source includes a battery other than the air secondary battery.

7. A vehicle having an air secondary battery system according to claim 5 mounted in it and using the electric power provided by the air secondary battery as at least part of its drive power.

8. The vehicle according to claim 7, wherein the vehicle uses either or both the air secondary battery and an internal combustion engine as drive power with alternated switching, and the heat source includes the internal combustion engine.
